(19) United States
(12) Patent Application Publication
(10) Pub. No.: US 2026/0163896 A1
(43) Pub. Date: Jun. 11, 2026

(54) AUTHENTICATION ATTEMPT ANOMALY DETECTION AND INTEGRITY RESTORATION

(71) Applicant: MASTERCARD INTERNATIONAL INCORPORATED, PURCHASE, NY (US)

(72) Inventor: Krishna Karthik NIMMAGADDA, Pune (IN)

(21) Appl. No.: 18/974,739

(22) Filed: Dec. 9, 2024

(51) Int. Cl. H04L 9/40; H04L 41/22

(52) U.S. Cl. CPC H04L 63/1425; H04L 41/22; H04L 63/1416

(57) ABSTRACT

A computer system, method, and storage device perform authentication attempt anomaly detection and integrity restoration. The authentication attempt comprises one or more messages sent between an authentication requestor and an authentication provider in a message stream. In response to a user input in a user interface, an anomaly category is generated comprising an authentication attempt anomaly condition and a responsive action. The authentication attempt anomaly condition represents an anomalous characteristic, state, or trait of an authentication attempt. A message is fetched from the message stream and compared to a condition of the anomaly category. When an anomaly of the authentication attempt meets the condition of the anomaly category, an action is initiated to restore the integrity of the authentication attempt according to the established responsive action of the anomaly category.

### BACKGROUND

Authentication methods and systems are crucial to securely prove a user's identity in various scenarios such as access control, online authentications, or login processes where security is valuable. Modern digital authentication systems typically involve components that route transaction messages between a user attempting to authenticate and an entity providing authentication. Authentication attempt messages sent between the requesting and providing entities are monitored to ensure authentication integrity and accurate recordation. The technical challenge of maintaining authentication integrity becomes pronounced when anomalies occur, such as missing messages, incorrect handling, or delayed responses, potentially leading to authentication discrepancies and extensive resolution timelines. This is especially problematic when the authentication attempt involves the transmission of sensitive information.

Current approaches to detect and resolve authentication attempt anomalies often require manual intervention or the deployment of new software updates, leading to computing inefficiencies, operational overhead, and an inability to promptly detect and respond to new anomalies. For example, traditional methods for handling anomalies typically lack adaptive capabilities, relying on hardcoded rules or static parameters that fail to cover the dynamic and evolving nature of authentication processing environments.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some examples provide a system comprising a processor; and a computer storage medium storing instructions that are operative upon execution by the processor to: in response to a user input in a user interface, establish an anomaly definition comprising an authentication attempt anomaly condition and a responsive action, the authentication attempt anomaly condition representing an anomalous characteristic, state, or trait of an authentication attempt, and wherein the authentication attempt comprises one or more messages sent between an authentication requestor and an authentication provider in a message stream; generate an anomaly category based on the anomaly definition; fetch a message associated with the authentication attempt from the message stream during a time period; determine whether the fetched message associated with the authentication attempt meets the authentication attempt anomaly condition represented by the anomaly category; and in response to the fetched message associated with the authentication attempt meeting the authentication attempt anomaly condition represented by the anomaly category, initiate an action to restore integrity of the authentication attempt according to the responsive action.

Other examples provide a method comprising: in response to a user input in a user interface, establishing an anomaly definition comprising an authentication attempt anomaly condition and a responsive action, the authentication attempt anomaly condition representing an anomalous characteristic, state, or trait of an authentication attempt, and wherein the authentication attempt comprises one or more messages sent between an authentication requestor and an authentication provider in a message stream; generating an anomaly category based on the anomaly definition; fetching a message associated with the authentication attempt from the message stream during a time period; determining whether the fetched message associated with the authentication attempt meets the authentication attempt anomaly condition represented by the anomaly category; and in response to the fetched message associated with the authentication attempt meeting the authentication attempt anomaly condition represented by the anomaly category, initiating an action to restore integrity of the authentication attempt according to the responsive action.

Further examples provide a non-transitory computer storage medium having computer-executable instructions for detecting an anomaly in an authentication attempt that, upon execution by a processor of a first node device, causes the processor to at least: in response to a user input in a user interface, establish an anomaly definition comprising an authentication attempt anomaly condition and a responsive action, the authentication attempt anomaly condition representing an anomalous characteristic, state, or trait of an authentication attempt, and wherein the authentication attempt comprises one or more messages sent between an authentication requestor and an authentication provider in a message stream; generate an anomaly category based on the anomaly definition; fetch a message associated with the authentication attempt from the message stream during a time period; determine whether the fetched message associated with the authentication attempt meets the authentication attempt anomaly condition represented by the anomaly category; and in response to the fetched message associated with the authentication attempt meeting the authentication attempt anomaly condition represented by the anomaly category, initiate an action to restore integrity of the authentication attempt according to the responsive action.

### BRIEF DESCRIPTION OF THE DRAWINGS

The present description will be better understood from the following detailed description read considering the accompanying drawings, wherein:

FIG. 1 is a block diagram illustrating an example system for detecting authentication attempt anomalies and restoring authentication integrity;

FIG. 2 is a block diagram illustrating an example system for detecting authentication attempt anomalies and restoring authentication integrity;

FIG. 3 is an example user interface for creating an anomaly definition;

FIG. 4 is a swim lane illustrating an example process of a computing device for detecting authentication attempt anomalies and initiating an action;

FIG. 5 is a flow chart illustrating an example process of a computing device for detecting authentication attempt anomalies and restoring authentication integrity; and

FIG. 6 illustrates an example computing apparatus as a functional block diagram.

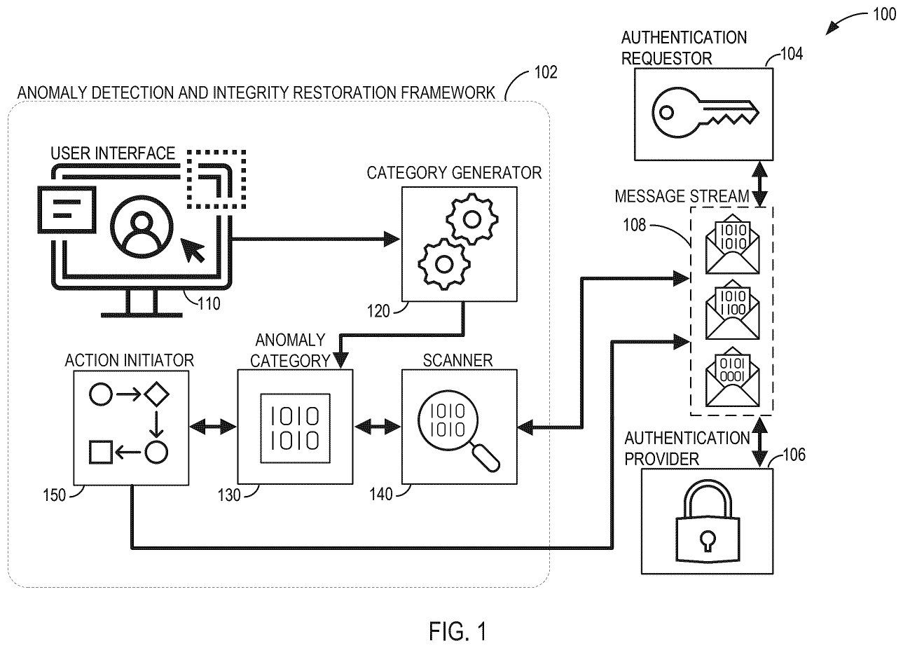

Corresponding reference characters indicate corresponding parts throughout the drawings. In FIGS. 1 to 2 and 4 to 6, the systems are illustrated as schematic drawings. The drawings may not be to scale. Any of the figures may be combined into a single example or embodiment.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

In an authentication attempt, one or more messages are sent between an authentication requestor, such as a user logging into an access terminal, and an authentication provider, such as a server evaluating the user's login credentials, in a message stream. In addition to authentication credentials, the messages can contain metadata or other information. Sometimes, one or more messages get lost, which leads to the authentication attempt either not completing, completing incorrectly, etc. Those authentication attempts are classified as “lacking integrity” because an anomaly occurred during the authentication attempt. The anomaly represents an anomalous characteristic, state, or trait of the authentication attempt. An anomaly is not an incomplete authentication per se, but rather a digression from an established path of authentication completion.

The integrity of an authentication attempt can be compromised either due to loss of messages in the network or due to incorrect handling of the transaction messages during authentication processing. The standard approach to detect and resolve anomalies is to hard code each individual anomaly scenario. However, anomalies defined this way cannot easily accommodate new error patterns or incorporate real-time rule changes without substantial redevelopment and redeployment efforts—an inefficient process in cases where potentially hundreds of anomaly conditions or fast anomaly detections are required.

Furthermore, existing solutions for anomaly management often lack user-friendly interfaces, presenting a substantial barrier for non-technical administrators responsible for maintaining the integrity of authentication attempts. The reliance on technical coding abilities for anomaly definition and resolution exacerbates delays and increases the dependency on specialized personnel. This constraint not only hampers timely anomaly resolution but also introduces a security risk due to delayed anomaly management.

In contrast, aspects of the disclosure improve the security of authentications by providing on-the-fly anomaly definition and integrity resolution. Aspects of the disclosure provide an authentication apparatus, system, and method that enable a user to define a new anomaly by stating a condition along with an action to take when the anomaly is found. A category generator automatically converts the definition into an anomaly category that represents the condition and action. The system then starts automatically searching for anomalies in authentication attempts by fetching messages associated with an authentication attempt from a message stream and comparing it with the condition of the anomaly category. If a message meets the condition of an anomaly category, the authentication attempt associated with that message is stored in that anomaly category. Periodically, the system checks all anomaly categories and initiates the assigned actions based on the met conditions to restore the integrity of the authentication attempt.

The computing device operates in an unconventional manner at least by automatically generating an anomaly category and scanning authentication attempts once an anomaly is defined. Compared to hard coded conditions, automatically generating an anomaly category and automatically scanning for anomalies reduces the processor, memory, and energy usage by the system by avoiding more computationally resource-intensive software deployments, thereby improving functioning of the underlying computing device. Additionally, automatically initiating actions when an anomaly is found removes the delay caused by manual decision-making, thereby reducing the overall time required to restore authentication attempt integrity under aspects of the disclosure. In some implementations, a user can also dynamically define an anomaly using natural language processing without having to write new code for a new anomaly scenario, thereby improving the human-machine interaction.

In addition, the disclosure describes automatically performing an action to restore authentication integrity when a message of an authentication attempt meets a defined anomaly condition. This is directed to a particular improvement in restoring authentication attempt integrity. Specifically, the method limits the automatic performance of a restoration action, such as the collection of additional message data or the transmission of confirmation messages, to when the initially collected message data reflects an abnormal condition, which avoids excess traffic volume on the network and degradation of network performance. The collected data can then be used to analyze the cause of the abnormal condition. This provides a specific improvement over prior systems, resulting in improved authentication attempt monitoring. The described processes are integrated into a practical application of improved authentication attempt monitoring.

Furthermore, in some implementations the disclosure enables the automatic presentation of user interface elements that result in improved user speed and effectiveness with the user interface. The disclosure describes automatically displaying suggested anomaly conditions and actions to the user based on a trained machine learning model. The automatically presented user interface elements improve human-computer interactions by presenting users with useful suggestions that can easily selected, resulting in an improved user interface for electronic devices.

Authentication attempts require credentials from an authentication requestor that satisfy an authentication provider to accept the authentication attempt. For the purposes of this disclosure, the authentication attempt can be any kind of electronic authentication, authorization, certification, validation, verification, login, or other confirmation attempt. In some implementations, the authentication attempt is an electronic user request to gain access to a building, room, storage container, facility, or other physical location. In other implementations, the authentication attempt is a digital user request to login to a network or computer at an access terminal, such as a university computer terminal; an update request from a client device to a server; a data synchronization request between servers; a payment transaction; or a cloud backup request by a client device to a cloud server, for example.

A message of an authentication attempt is a discrete data segment that is transmitted from a specified sender to a specified recipient as part of the authentication attempt. Depending on the implementation, the message can contain credentials for authentication, a response acknowledging receipt of a prior message, a cryptogram, a token, timestamps, geolocation data, intended recipients, user identification data, a transaction amount or type, an internet protocol (IP) address, or other data/metadata. Messages convey important information about the authentication attempt. If a message is lost, delayed, or corrupted for example, then a digression from the expected path of authentication completion has occurred.

Depending on the implementation, the authentication requestor can be an individual operating an access control device, such as an access control keypad, a card/fob reader, a smart lock, a computer terminal, a mobile device, or a point-of-sale machine, or an entity operating a computer system, server, or network, such as a university or bank/acquirer. Similarly, depending on the implementation, the authentication provider can be a physical security system or device, such as a smart lock, a server, database, or webpage, or another entity operating a computer system, server, or network, such as another university or bank/issuer.

FIG. 1 illustrates a block diagram of a system 100 for detecting authentication attempt anomalies and restoring authentication integrity. A user interface (UI) 110, a category generator 120, an anomaly category 130, a scanner 140, and an action initiator 150 collectively comprise an anomaly detection and integrity restoration framework 102. An authentication requestor 104 and an authentication provider 106 exchange messages in a message stream 108 as part of an authentication attempt. The framework 102 analyzes messages from the message stream 108 to detect anomalies and restore integrity.

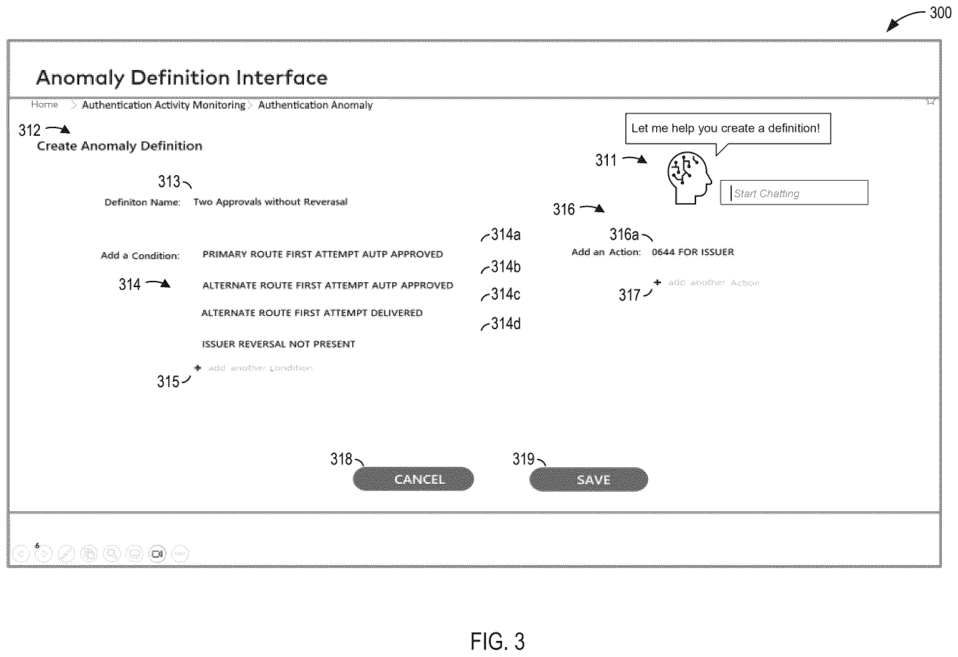

The UI 110 enables a user to define one or more new anomalies by specifying qualifying conditions and actions to perform upon detection. Each anomaly definition can comprise one or more conditions and one or more integrity restoration actions. In some versions, the anomaly conditions are defined using a logic structure such as “if (Condition1 && Condition2 & conditionN) {then (Actions)}”. The logic structure can include logic operators for each condition such as AND, OR, and NOT. Additionally, the conditions can include quantity operators such as greater than, less than, etc. This interface allows for specifying multiple conditions and corresponding actions for each identified anomaly. A user can enter the conditions and actions in the UI 110 in text boxes, by selecting predetermined conditions such as from a dropdown box, or by using natural language for example. In at least one embodiment, the UI 110 is the UI 300 shown in FIG. 3.

The category generator 120 receives the defined anomaly from the UI 110 and automatically generates an anomaly category 130 based on the defined conditions and actions to take. The category generator 120 converts user input from the UI 110 into machine-readable instructions. The anomaly category 130 is a data structure that stores authentication attempts that meet its defined conditions. Depending on the implementation, storing authentication attempts includes storing an authentication attempt identifier that identifies the authentication attempt, storing a message or a datum of a message fetched from the message stream 108, or storing some other data generated or received in response to meeting the condition of the anomaly category 130. The category generator 120 generates an anomaly category 130 for each defined anomaly.

A scanner 140 periodically fetches messages of authentication attempts from a message stream 108. The scanning time period can be configured by a system administrator. In at least one embodiment, the scanning time period is some time period prior to a current time (e.g., between 2-6 hours prior to the current time). The scanner 140 scans the messages from the message stream 108 and compares them to the conditions of the anomaly category 130. Scanning message from the message stream 108 periodically saves computational resources (e.g., network bandwidth, processing time, energy, etc.) compared to constantly scanning the message stream 108 for new messages at least because of the fewer fetch attempts from the scanner 140 to the message stream 108. In some implementations, periodically scanning messages from the message stream also allows for the messages to be screened in bulk, enabling the use of more efficient computing processes, such as parallel processing, to thereby save additional computational resources.

If one or more messages of an authentication attempt meet the conditions of the anomaly category 130, then the scanner 140 stores the authentication attempt in the anomaly category 130. Storing the authentication attempt in the anomaly category 130 can include storing one or more messages of the authentication attempt, storing an authentication attempt identifier, or some other data relating to the authentication attempt.

The action initiator 150 is configured to automatically perform various actions in response to authentication attempts meeting the conditions of the anomaly category 130. The action initiator 150 periodically scans the anomaly category 130 and automatically initiates an action if one or more authentication attempts are stored in the anomaly category 130. The action is based on what is defined in the action part of the anomaly category 130. For example, the action can be generating a new message identifying a missing message of the authentication attempt that is sent through the message stream 108 to the authentication requestor 104 or the authentication provider 106. The action time period can be configured by a system administrator. The action initiator 150 periodically scanning the anomaly category 130 saves computational resources in a similar way as the scanner 140 periodically scanning the message stream 108 as described above.

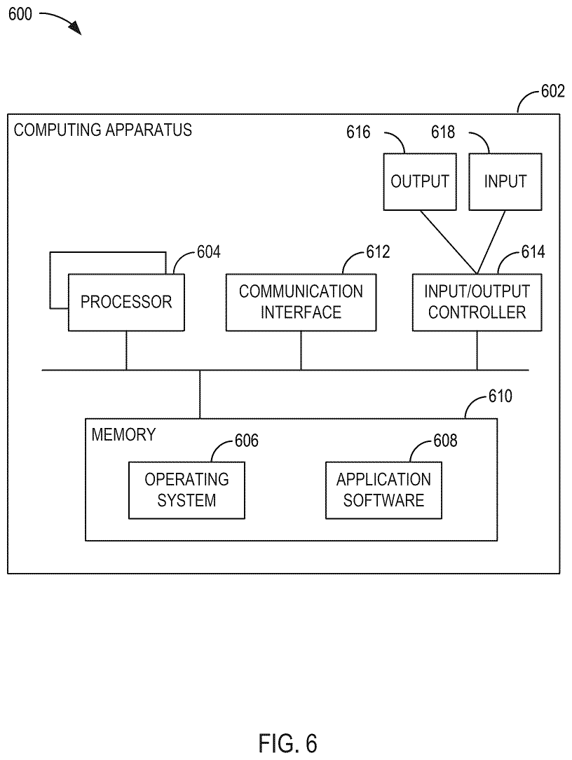

Further, in some examples, the system 100 includes one or more computing devices (e.g., the computing apparatus of FIG. 6) that are configured to communicate with each other via one or more communication networks (e.g., an intranet, the Internet, a cellular network, other wireless network, other wired network, or the like). The framework 102 may also comprise one or more computing devices. In some examples, entities of the system 100 are configured to be distributed between the multiple computing devices and to communicate with each other via network connections. For example, UI 110 is executed on a first computing device and the category generator 120 is located on a second computing device within the system 100. The first computing device and second computing device are configured to communicate with each other via network connections. Alternatively, in some examples, other components of the category generator 120 (e.g., machine-learning models that assist in generating anomaly categories) are executed on separate computing devices and those separate computing devices are configured to communicate with each other via network connections during the operation of the framework 102. In other examples, other organizations of computing devices are used to implement system 100 without departing from the description.

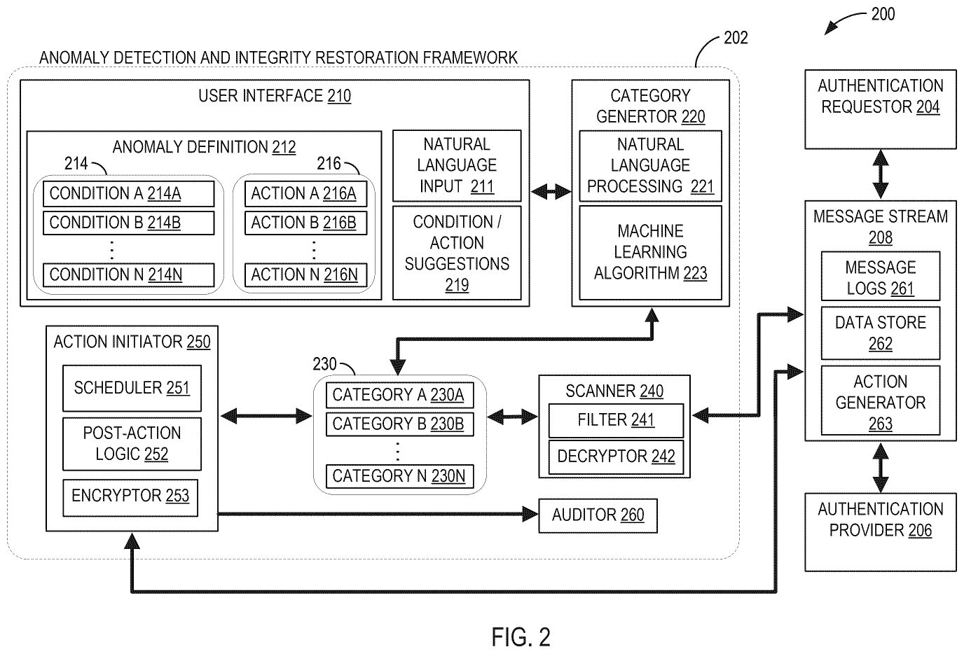

FIG. 2. is a block diagram illustrating an example system 200 for detecting authentication attempt anomalies and restoring authentication integrity. A UI 210, a category generator 220, an anomaly category 230, a scanner 240, and an action initiator 250 collectively comprise an anomaly detection and integrity restoration framework 202. An authentication requestor 204 and an authentication provider 206 exchange messages in a message stream 208 as part of an authentication attempt. The framework 202 analyzes messages from the message stream 208 to detect anomalies and restore integrity. Aspects of the system 200 correspond to aspects of system 100 in FIG. 1 and vice versa unless stated otherwise.

The UI 210 enables a user to define one or more new anomalies by specifying conditions and actions. The UI 210 may include a graphical user interface (GUI) featuring input fields for defining anomaly conditions and actions. The user can interact with a visual anomaly definition 212 portion of the UI 210 to state one or more of condition A 214A, condition B 214B, . . . and condition N 214N (collectively conditions 214) and one or more of action A 216A, action B 216B, . . . and action N 216N (collectively actions 214). In some embodiments, a user can provide natural language input 211 to define an anomaly using a natural language description of the conditions and actions to take. In at least one embodiment, the UI 210 is the UI 300 shown in FIG. 3.

In some embodiments, the UI 210 includes one or more condition/action suggestions for the user to create the anomaly definition. The one or more condition/action suggestions may appear as an icon or text for the user to select. Alternatively, the one or more condition/action suggestions are in a natural language response in response to a user's natural language input 211. In at least one embodiment, the one or more condition/action suggestions 219 are provided as part of an auto-complete function when the user enters a condition or action in an input field. Presenting condition/action suggestions 219 in or near a corresponding condition/action input field in the UI 210 improves a user's ability to input conditions or actions, thereby improving human-computer interaction.

The category generator 220 automatically generates one or more of anomaly category A 230A, anomaly category B 230B, . . . and anomaly category N 230N (collectively anomaly categories 230) based on the defined conditions and actions to take for each. In some implementations, the category generator 220 includes natural language processing (NLP) 221 to interpret user-input natural language into machine-readable instructions. In some implementation, the category generator 220 may utilize a machine learning (ML) algorithm 223, such as a trained ML model, to generate anomaly categories 230. The ML algorithm 223 may facilitate the efficient generation of categories, thereby saving computational resources to detect anomalies.

In some versions, the category generator 220 is configured to generate new anomaly conditions and actions to take on-the-fly. After the scanner 240 fetches messages and stores authentication attempts in anomaly categories 230, the category generator 220 receives the anomaly categories 230 with stored authentication attempts. The category generator 220 analyzes the received anomaly categories 230 to generate new anomaly categories 230 based on an on-the-fly criteria. The on-the-fly criteria is a rule or condition based on the received anomaly categories storing authentication attempts. In at least one implementation, the on-the-fly criteria is a threshold number of anomalies occurring within a time period. Once the on-the-fly criteria is met, it guides the category generator 220 in generating new conditions and actions. In some implementations, the on-the-fly criteria causes the category generator 220 to generate conditions and actions based on a type of data of messages in the stored authentication attempts of the received anomaly categories. In at least one embodiment, the ML algorithm 223 is configured to generate the new anomaly conditions and actions to take on the fly. Automatically generating new anomaly conditions on-the-fly reduces the latency to detect and address additional anomalies.

In yet other implementations, the ML algorithm 223 is configured to generate the one or more condition/action suggestions 219 for the UI 210. In some examples, the ML algorithm 223 is a ML model trained on a dataset of anomaly categories. The ML model infers an action based on an input condition or vice versa. The conditions/actions are presented in the UI 210 as condition/action suggestions 219. In at least one embodiment, the one or more condition/action suggestions 219 are anomaly conditions and actions to take that are generated on-the-fly, but that aren't automatically implemented as anomaly categories unless selected by a user in the UI 210. Presenting suggestions to a user improves the user's speed and effectiveness in determining conditions and actions in the UI 210, thereby improving human-computer interaction.

The scanner 240 periodically fetches messages of authentication attempts from the message stream 208. The messages may be stored in message logs 261 or a message data store 262 in the message stream 208. In at least one embodiment, the message stream 208 is a transaction switch. In some implementations, the scanner 240 includes a filter 241 to handle high volumes of authentication attempts. The filter 241 may utilize the data/metadata aspects of the messages described above as filtering criteria. For example, the filtering criteria can include message type, size, amount, or timestamp. The inclusion of a filter 241 reduces the volume of data that the scanner 240 parses, ensuring that the scanner 240 efficiently processes only relevant authentication attempts against the defined anomaly conditions. This saves network bandwidth, processing resources, time, and energy.

A message may be partially or fully encrypted, in which case the framework 202 may only be able to analyze unencrypted portions of the message. Alternatively, the framework 202 may include a decryptor 242 in the scanner 240 to decrypt the encrypted authentication attempt messages. Depending on the encryption technology, the decryptor 242 may need to securely store a key or token to decrypt the message.

The action initiator 250 is configured to automatically perform various actions in response to authentication attempts meeting the conditions of the anomaly categories 230. In some implementations, the action initiator includes a scheduler 251, post-action logic 252, and an encryptor 253. The scheduler 251 may be configured to determine optimal times for executing corrective actions. The scheduler 251 can take into account various factors such as network load, time of day, transaction periods, and priority levels of anomalies to ensure minimal disruption to authentication processing.

In some versions, an encryptor 253 of the action initiator 250 encrypts messages or actions sent into the message stream 208. Messages or actions that include sensitive data, such as a user authentication identifier, are better secured through encryption. The encryptor 253 can use the same form of encryption as the decryptor 242. Encrypting outgoing messages improves the security of the system 200 by reducing the likelihood of disclosing sensitive data.

In some implementations, after an action is initiated by the action initiator 250, the action initiator 250 performs post-action logic 252, such as automatically looking for an acknowledgment that the action was performed successfully. For example, the successful action acknowledgement can include receiving a response that an intended recipient received a generated message. If an acknowledgement is not received within a time limit, then the post-action logic 252 can cause the action initiator 250 to attempt to repeat the action again or otherwise perform a secondary action. The secondary action can include an action that does not restore authentication integrity by itself, but instead alerts an additional entity that the authentication attempt has an anomaly that wasn't automatically resolved. If an acknowledgement is not received for the secondary action, then the post-action logic 252 can cause the action initiator 250 to attempt to repeat the secondary action or otherwise perform a tertiary (third, fourth, etc.) action. Post-action logic improves the performance of a computing device operating the framework 202 by adding additional automatic contingency operations if the actions are not successful. This reduces the time to restore authentication integrity, thereby improving the performance of the system 200.

Sometimes the framework 202 does not have sufficient permissions to immediately restore authentication integrity by itself. In this scenario, the action initiator 250 performs an action or generate a message to cause an action generator 263 in the message stream 208 to perform an additional integrity restoration action, such as generating a further message alert to either the authentication requestor 204 or provider 206. The action generator 263 may have greater permissions or more-efficient processing capabilities than the action initiator 250 of the framework 202 to restore authentication integrity. Thus, using an action generator 263 in the message stream 208 improves network security when the framework 202 has reduced permissions.

In at least one embodiment, the framework 202 includes an auditor 260 that logs all detected anomalies and the corresponding actions taken. The auditor 260 may provide reports that can be reviewed by administrators for compliance and performance assessments, thereby enhancing the overall reliability and transparency of the framework 202.

FIG. 3 is an example user interface (UI) 300 for creating an anomaly definition. The UI 300 includes an anomaly definition portion 312 that includes a condition input field 314 and an action input field 316. In some implementations, the UI 300 is presented as a GUI in a user device. A user may use text or voice input to define conditions and actions of an authentication attempt anomaly. The UI 300 can also include an anomaly definition name 313 input field. In some implementations, the UI 300 further includes a cancel icon 318 and a save icon 319 that enable a user to cancel or save the currently defined anomaly respectively.

In some versions, the UI 300 includes a natural language input field 311. The natural language input field 311 enables a user to input a natural language description of the anomaly and what actions they want to occur when the anomaly is detected. The natural language input via activation of field 311 is interpreted through NLP, such as NLP 221 of FIG. 2 to interpret the user's input into machine-readable instructions. In at least one embodiment, the UI 300 presents one or more condition/action suggestions as a response to a user's natural language input.

The UI 300 further includes functionality to add more conditions and actions as necessary. The condition input field 314 can include a selectable add another condition icon 315 and the action input field 316 can include a selectable add another action icon 317 to add an additional condition or action to the condition input field 314 or action input field 316 respectively. In some implementations, anomalies are defined using a logic structure such as “if (Condition1 && Condition2 & conditionN) {then (Actions)}”. This allows for specifying multiple conditions and corresponding actions for each identified anomaly.

In the example shown in FIG. 3, the anomaly definition name 313 is “Two Approvals without Reversal.” The example anomaly definition 312 includes four conditions 314: “primary route first attempt autp approved” 314a, “alternate route first attempt autp approved” 314b, “alternate route first attempt delivered” 314c, and “issuer reversal not present” 314d. The action 316 of the definition 312 is “0644 for issuer”, which represents a specific type of message to be sent to an authentication provider, such as authentication provider 106 shown in FIG. 1, indicating that a message of the authentication attempt was not delivered to a user. The authentication provider can then attempt to redeliver the missing message or perform some other corrective action.

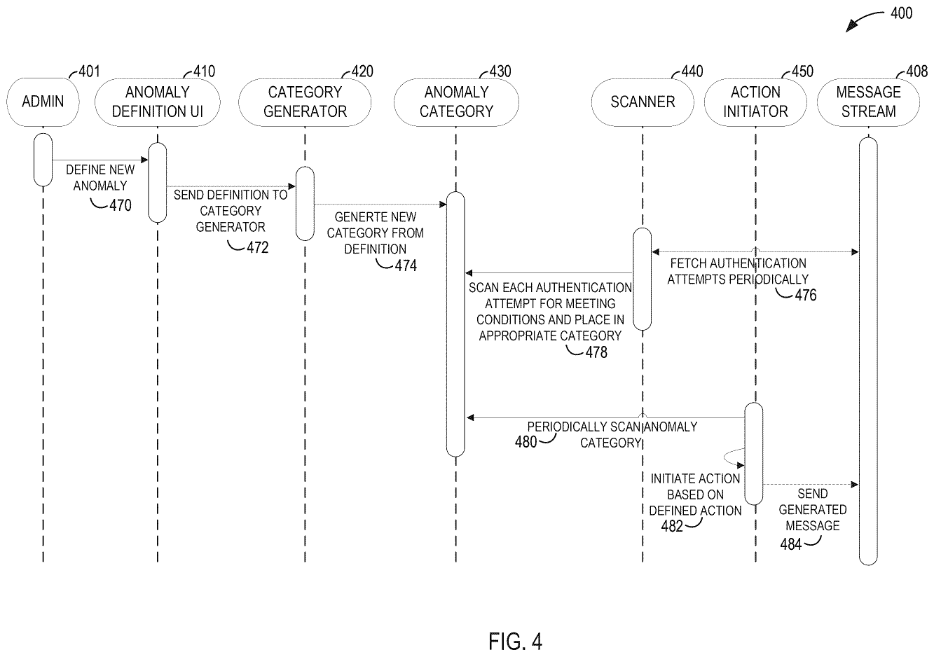

FIG. 4 is a swim lane illustrating an example process 400 of a computing device for detecting authentication attempt anomalies and initiating an action to restore authentication attempt integrity. The operations of process 400 may be implemented using the other aspects of the disclosure, such as the systems of FIGS. 1 and 2.

At operation 470, an administrator 401 operating an anomaly definition UI 410 defines a new anomaly of an authentication attempt. The anomaly definition includes an anomaly condition and an action to take once detected.

At operation 472, the anomaly definition UI 410 sends the anomaly definition to a category generator 420.

At operation 474, the category generator 420 generates a new anomaly category 430 from the received anomaly definition. The anomaly category 434 is a data structure that includes the defined condition and action.

At operation 476, a scanner 440 fetches authentication attempts periodically from a message stream 408. Fetching authentication attempts can include fetching individual messages of an authentication attempt. In at least one embodiment, the time period is between 2-6 hours.

At operation 478, the scanner 440 scans each authentication attempt for matching conditions to the anomaly category 430 and places the authentication attempt there. If there are multiple anomaly categories 430, then the scanner 440 places the authentication attempt in each anomaly category that meets that category's conditions.

At operation 480, an action initiator 450 periodically scans the anomaly category 430. If the anomaly category has a placed authentication attempt, then the swim lane 400 proceeds to operation 482.

At operation 482, the action initiator 450 initiates an action based on the defined action of the anomaly category 430. The action restores the integrity of the authentication attempt or otherwise alerts an appropriate entity that the authentication attempt lacks integrity.

Optionally, at operation 484, the action initiator 450 sends a generated message back to the message stream 408. The generated message may alert an appropriate entity connected to the message stream 408 that the authentication attempt lacks integrity or otherwise cause an authentication integrity restoring action.

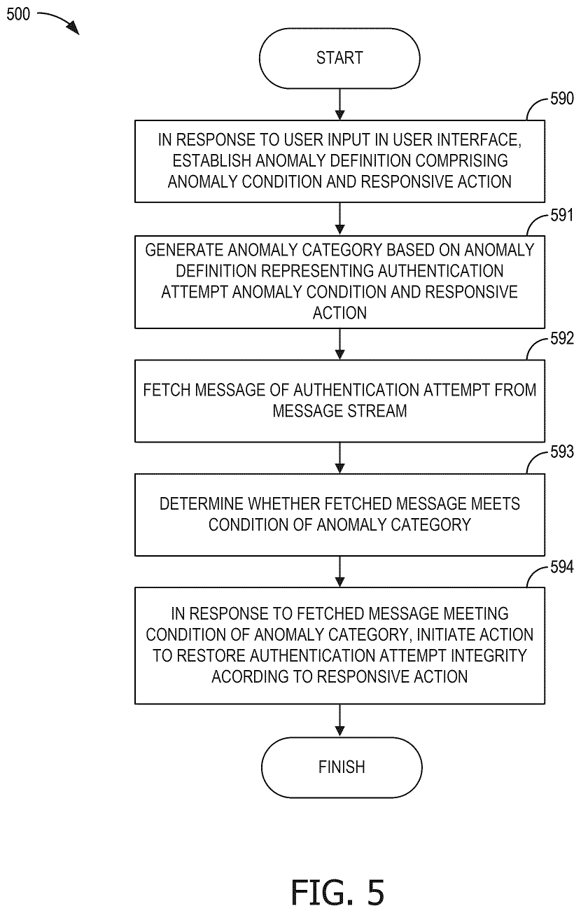

FIG. 5 illustrates a flow chart illustrating an example process 500 of a computing device for detecting authentication attempt anomalies and restoring authentication integrity. Process 500 begins at operation 590. Process 500 can be implemented using the systems and methods of the disclosure, such as the systems shown in FIGS. 1 and 2.

At operation 590, the computing devices establishes an anomaly category in response to a user input in a user interface. The anomaly category comprises an authentication attempt anomaly condition and a responsive action, the authentication attempt anomaly condition representing an anomalous characteristic, state, or trait of an authentication attempt. The authentication attempt comprises one or more messages sent between an authentication requestor and an authentication provider in a message stream.

At operation 591, the computing device generates an anomaly category representing the corresponding anomaly condition and the responsive action.

At operation 592, the computing device fetches a message of the authentication attempt from the message stream.

At operation 593, the computing device compares the fetched message of the authentication attempt with the anomaly category.

At operation 594, the computing device initiate an action to restore the integrity of the authentication attempt according to the responsive action in response to an anomaly of the authentication attempt meeting the anomaly category. The process 500 finishes following completion of operation 594.

### Additional Example Implementations

Various combinations of anomaly conditions and actions are envisioned for implementing the disclosure. The following anomaly conditions and actions are provided as examples:

In response to the detection of repeated data requests for the same information by a client device without receiving a corresponding acknowledgment message from the data repository, initiate a notification to the data repository to verify the client's request status and, if necessary, temporarily restrict further requests from the client device until resolution, ensuring efficient data exchange management.

In response to the occurrence of a data synchronization request from a primary server to a backup server with inconsistencies in the timestamp indicating a potential mismatch in data sets, automatically trigger a complete data synchronization between the primary and backup servers to reconcile the data sets and generate a confirmation log for the synchronization event.

In response to an absence of a confirmation signal from an internet of things (IoT) device after multiple configuration update attempts by the central control unit, dispatch a diagnostic communication to the IoT device requesting a status report and alert the technical team if the status report fails to resolve within a specified time frame.

In response to the detection of an encryption key exchange process initiation without subsequent acknowledgment from the receiving device (thereby suggesting a failure in the secure communication setup), log the attempted key exchange for review and automatically attempt a secondary secure connection setup sequence using an alternative encryption method.

In response to an automatic update initiation sequence from a software server lacking a corresponding completion notification from the client application within an expected timeframe, generating and sending a status inquiry to the client application to determine any issues during the update process and redeploy the update sequence if necessary to ensure application consistency.

In response to multiple transaction approvals occurring on a primary route, but not receiving an issuer reversal after a set time interval, initiating a message to the issuer requesting immediate reversal of any unprocessed approvals to avoid double postings.

In response to a transaction being marked as approved, but the corresponding fund release confirmation is not received within a pre-determined time frame, sending an alert to the transaction processor to check the status of the fund release and, if necessary, automatically trigger a follow-up transaction message for processing.

In response to detecting the presence of an authorization message without subsequent settlement entry after a prescribed monitoring window, sending a notification to the authentication requestor to verify the transaction status and execute a settlement retry if required.

In response to detecting a discrepancy between the transaction amount authorized and the transaction amount settled, dispatching a corrective adjustment transaction to align the settled amount with the authorized transaction amount, thereby reestablishing authentication attempt integrity.

### Exemplary Operating Environment

The present disclosure is operable with a computing apparatus according to an embodiment as a functional block diagram 600 in FIG. 6. In an example, components of a computing apparatus 602 are implemented as a part of an electronic device according to one or more embodiments described in this specification. The computing apparatus 602 comprises one or more processors 604 which may be microprocessors, controllers, or any other suitable type of processors for processing computer executable instructions to control the operation of the electronic device. Alternatively, or in addition, the processor 604 is any technology capable of executing logic or instructions, such as a hard-coded machine. In some examples, platform software comprising an operating system 606 or any other suitable platform software is provided on the apparatus 602 to enable application software 608 to be executed on the device. In some examples, detecting anomalies and restoring integrity to authentication attempts as described herein is accomplished by software, hardware, and/or firmware.

In some examples, computer executable instructions are provided using any computer-readable media that is accessible by the computing apparatus 602. Computer-readable media include, for example, computer storage media such as a memory 610 and communications media. Computer storage media, such as a memory 610, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 610) is shown within the computing apparatus 602, it will be appreciated by a person skilled in the art, that, in some examples, the storage is distributed or located remotely and accessed via a network or other communication link (e.g., using a communication interface 612).

Further, in some examples, the computing apparatus 602 comprises an input/output controller 614 configured to output information to one or more output devices 616, for example a display or a speaker, which are separate from or integral to the electronic device. Additionally, or alternatively, the input/output controller 614 is configured to receive and process an input from one or more input devices 618, for example, a keyboard, a microphone, or a touchpad. In one example, the output device 616 also acts as the input device. An example of such a device is a touch sensitive display. The input/output controller 614 may also output data to devices other than the output device, e.g., a locally connected printing device. In some examples, a user provides input to the input device(s) 618 and/or receives output from the output device(s) 616.

The functionality described herein can be performed, at least in part, by one or more hardware logic components. According to an embodiment, the computing apparatus 602 is configured by the program code when executed by the processor 604 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a computer storage medium storing instructions that are operative upon execution by the processor to: in response to a user input in a user interface, establish an anomaly definition comprising an authentication attempt anomaly condition and a responsive action, the authentication attempt anomaly condition representing an anomalous characteristic, state, or trait of an authentication attempt, and wherein the authentication attempt comprises one or more messages sent between an authentication requestor and an authentication provider in a message stream; generate an anomaly category based on the anomaly definition; fetch a message associated with the authentication attempt from the message stream during a time period; determine whether the fetched message associated with the authentication attempt meets the authentication attempt anomaly condition represented by the anomaly category; and in response to the fetched message associated with the authentication attempt meeting the authentication attempt anomaly condition represented by the anomaly category, initiate an action to restore integrity of the authentication attempt according to the responsive action.

An example computerized method comprises: in response to a user input in a user interface, establishing an anomaly definition comprising an authentication attempt anomaly condition and a responsive action, the authentication attempt anomaly condition representing an anomalous characteristic, state, or trait of an authentication attempt, and wherein the authentication attempt comprises one or more messages sent between an authentication requestor and an authentication provider in a message stream; generating an anomaly category based on the anomaly definition; fetching a message associated with the authentication attempt from the message stream during a time period; determining whether the fetched message associated with the authentication attempt meets the authentication attempt anomaly condition represented by the anomaly category; and in response to the fetched message associated with the authentication attempt meeting the authentication attempt anomaly condition represented by the anomaly category, initiating an action to restore integrity of the authentication attempt according to the responsive action.

An example non-transitory computer storage medium comprises computer-executable instructions for detecting an anomaly in an authentication attempt that, upon execution by a processor of a first node device, causes the processor to at least: in response to a user input in a user interface, establish an anomaly definition comprising an authentication attempt anomaly condition and a responsive action, the authentication attempt anomaly condition representing an anomalous characteristic, state, or trait of an authentication attempt, and wherein the authentication attempt comprises one or more messages sent between an authentication requestor and an authentication provider in a message stream; generate an anomaly category based on the anomaly definition; fetch a message associated with the authentication attempt from the message stream during a time period; determine whether the fetched message associated with the authentication attempt meets the authentication attempt anomaly condition represented by the anomaly category; and in response to the fetched message associated with the authentication attempt meeting the authentication attempt anomaly condition represented by the anomaly category, initiate an action to restore integrity of the authentication attempt according to the responsive action.

Alternatively, or in addition to the other examples described herein, examples include any combination of the following:
the user interface comprises natural language processing capabilities configured to interpret natural language into machine-readable instructions;
the initiated action comprises sending a message to an action generator in the message stream;
in response to the fetched message associated with the authentication attempt meeting the authentication attempt anomaly condition represented by the anomaly category, store the authentication attempt in the anomaly category;
determine whether the stored authentication attempt meets an on-the-fly criteria;
in response to the stored authentication attempt meeting the on-the-fly criteria, automatically generate a second anomaly category;
the time period is between 2 to 6 hours after the authentication attempt begins;
the time period is a window having duration of 2 to 6 hours;
the time period is between 2 to 6 hours prior to a current time;
filtering the fetched message according to an authentication attempt criterion;
decrypting the fetched message from the message stream; and
display a suggested condition in a condition input field in the user interface, wherein the suggested condition is generated according to a machine learning model trained on a dataset comprising combinations of anomaly conditions and responsive actions.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
in response to a user input in a user interface, establish an anomaly definition comprising an authentication attempt anomaly condition and a responsive action, the authentication attempt anomaly condition representing an anomalous characteristic, state, or trait of an authentication attempt, and wherein the authentication attempt comprises one or more messages sent between an authentication requestor and an authentication provider in a message stream;
generate an anomaly category based on the anomaly definition;
fetch a message associated with the authentication attempt from the message stream during a time period;
determine whether the fetched message associated with the authentication attempt meets the authentication attempt anomaly condition represented by the anomaly category; and
in response to the fetched message associated with the authentication attempt meeting the authentication attempt anomaly condition represented by the anomaly category, initiate an action to restore integrity of the authentication attempt according to the responsive action.

2. The system of claim 1, wherein the user interface comprises natural language processing capabilities configured to interpret natural language into machine-readable instructions.

3. The system of claim 1, wherein the memory and the computer program code are further configured to cause the processor to:
in response to the fetched message associated with the authentication attempt meeting the authentication attempt anomaly condition represented by the anomaly category, store the authentication attempt in the anomaly category;
determine whether the stored authentication attempt meets an on-the-fly criteria; and
in response to the stored authentication attempt meeting the on-the-fly criteria, automatically generate a second anomaly category.

4. The system of claim 1, wherein the time period is between 2 to 6 hours after the authentication attempt begins.

5. The system of claim 1, wherein the memory and the computer program code are further configured to cause the processor to:
filter the fetched message according to an authentication attempt criterion.

6. The system of claim 1, wherein the memory and the computer program code are further configured to cause the processor to:
decrypt the fetched message from the message stream.

7. The system of claim 1, further comprising:
display a suggested condition in a condition input field in the user interface, wherein the suggested condition is generated according to a machine learning model trained on a dataset comprising combinations of anomaly conditions and responsive actions.

8. A computer-implemented method comprising:
in response to a user input in a user interface, establishing an anomaly definition comprising an authentication attempt anomaly condition and a responsive action, the authentication attempt anomaly condition representing an anomalous characteristic, state, or trait of an authentication attempt, and wherein the authentication attempt comprises one or more messages sent between an authentication requestor and an authentication provider in a message stream;
generating an anomaly category based on the anomaly definition;
fetching a message associated with the authentication attempt from the message stream during a time period;
determining whether the fetched message associated with the authentication attempt meets the authentication attempt anomaly condition represented by the anomaly category; and
in response to the fetched message associated with the authentication attempt meeting the authentication attempt anomaly condition represented by the anomaly category, initiating an action to restore integrity of the authentication attempt according to the responsive action.

9. The computer-implemented method of claim 8, wherein the user interface comprises natural language processing capabilities configured to interpret natural language into machine-readable instructions.

10. The computer-implemented method of claim 8, further comprising:
in response to the fetched message associated with the authentication attempt meeting the authentication attempt anomaly condition represented by the anomaly category, storing the authentication attempt in the anomaly category;
determining whether the stored authentication attempt meets an on-the-fly criteria; and
in response to the stored authentication attempt meeting the on-the-fly criteria, automatically generating a second anomaly category.

11. The computer-implemented method of claim 8, wherein the time period is a window having duration of 2 to 6 hours.

12. The computer-implemented method of claim 8, further comprising:
filtering the fetched message according to an authentication attempt criterion.

13. The computer-implemented method of claim 8, further comprising:
decrypting the fetched message from the message stream.

14. The computer-implemented method of claim 8, further comprising:
displaying a suggested condition in a condition input field in the user interface, wherein the suggested condition is generated according to a machine learning model trained on a dataset comprising combinations of anomaly conditions and responsive actions.

15. A non-transitory computer storage medium having computer-executable instructions for detecting an anomaly in an authentication attempt that, upon execution by a processor of a first node device, causes the processor to at least:
in response to a user input in a user interface, establish an anomaly definition comprising an authentication attempt anomaly condition and a responsive action, the authentication attempt anomaly condition representing an anomalous characteristic, state, or trait of an authentication attempt, and wherein the authentication attempt comprises one or more messages sent between an authentication requestor and an authentication provider in a message stream;
generate an anomaly category based on the anomaly definition;
fetch a message associated with the authentication attempt from the message stream during a time period;
determine whether the fetched message associated with the authentication attempt meets the authentication attempt anomaly condition represented by the anomaly category; and
in response to the fetched message associated with the authentication attempt meeting the authentication attempt anomaly condition represented by the anomaly category, initiate an action to restore integrity of the authentication attempt according to the responsive action.

16. The non-transitory computer storage medium of claim 15, wherein the user interface comprises natural language processing capabilities configured to interpret natural language into machine-readable instructions.

17. The non-transitory computer storage medium of claim 15, wherein the computer-executable instructions, upon execution by a processor, further cause the processor to at least:
in response to the fetched message associated with the authentication attempt meeting the authentication attempt anomaly condition represented by the anomaly category, store the authentication attempt in the anomaly category;
determine whether the stored authentication attempt meets an on-the-fly criteria; and
in response to the stored authentication attempt meeting the on-the-fly criteria, automatically generate a second anomaly category.

18. The non-transitory computer storage medium of claim 15, wherein the time period is between 2 to 6 hours prior to a current time.

19. The non-transitory computer storage medium of claim 15, wherein the computer-executable instructions, upon execution by a processor, further cause the processor to at least:
filtering the fetched message according to an authentication attempt criterion.

20. The non-transitory computer storage medium of claim 15, wherein the computer-executable instructions, upon execution by a processor, further cause the processor to at least:
decrypting the fetched message from the message stream.
